(19) United States
(12) Patent Application Publication
(10) Pub. No.: US 2006/0125726 A1
(43) Pub. Date: Jun. 15, 2006

(54) Plasma display apparatus

(76) Inventors: Gi Bum Lee, Changwon-si (KR); Yun Kwon Jung, Gumisi (KR)

Correspondence Address: FLESHNER & KIM, LLP, P.O. BOX 221200, CHANTILLY, VA, 20153, US

(21) Appl. No.: 11/295,683

(22) Filed: Dec. 7, 2005

(30) Foreign Application Priority Data
Dec. 8, 2004 (KR) 10-2004-0103260

(51) Int. Cl. G09G 3/28

(52) U.S. Cl. 345/67

(57) ABSTRACT

The present invention relates to a plasma display apparatus. A plasma display apparatus according to the present invention comprises a plasma display panel comprising a scan electrode and a sustain electrode, a scan driver for applying a negative voltage to the scan electrode before a reset period when the scan electrode is applied with a positive voltage and a sustain driver for applying a positive voltage to the sustain electrode while the scan electrode is applied with a negative voltage.

This Nonprovisional application claims priority under 35 U.S.C. § 119(a) on Patent Application No. 10-2004-0103260 filed in Korea on Dec. 8, 2005 the entire contents of which are hereby incorporated by reference.

### BACKGROUND OF THE INVENTION

1. Field of the Invention

The present invention relates to a plasma display apparatus.

2. Description of the Background Art

In general, in a plasma display panel, a barrier rib formed between a front substrate and a rear substrate forms one unit cell. Each cell is filled with a main discharge gas such as neon (Ne), helium (He) or a mixed gas (Ne+He) of Ne and He, and an inert gas containing a small amount of xenon. If the inert gas is discharged with a high frequency voltage, it generates vacuum ultraviolet rays. Phosphors formed between the barrier ribs are light-emitted to display images. This plasma display panel can be made thin and slim, and has thus been in the spotlight as the next-generation display devices.

FIG. 1 shows the construction of a common plasma display panel.

As shown in FIG. 1, the plasma display panel comprises a front substrate 100 and a rear substrate 110. The front substrate 100 has a plurality of sustain electrode pairs arranged on a front substrate 101 serving as the display surface on which the images are displayed. Each of the sustain electrode pairs has scan electrodes 102 and sustain electrodes 103. The rear substrate 110 has a plurality of address electrodes 113 arranged on a rear substrate 111 serving as the rear surface. The address electrodes 113 cross the plurality of sustain electrode pairs. At this time, the front substrate 100 and the rear substrate 110 are parallel to each other with a predetermined distance therebetween.

The front substrate 100 comprises pairs of the scan electrodes 102 and the sustain electrodes 103 for discharging the other one in one discharge cell and maintaining emission of cells. That is, each of the scan electrode 102 and the sustain electrode 103 has a transparent electrode “a” made of a transparent ITO material, and a bus electrode “b” made of a metal material. The scan electrodes 102 and the sustain electrodes 103 are covered with one or more upper dielectric layers 104 for limiting a discharge current and providing insulation among the electrode pairs. A protection layer 105 on which magnesium oxide (MgO) is deposited in order to facilitate a discharge condition is formed on the entire surface of the upper dielectric layer 104.

Stripe type (or well type) barrier ribs 112 for forming a plurality of discharge spaces (i.e., discharge cells) are arranged parallel to each other on the rear substrate 110. Further, a number of address electrodes 113 for generating vacuum ultraviolet rays by performing an address discharge is disposed parallel to the barrier ribs 112. R, G and B phosphors 114 for emitting a visible ray for image display upon address discharge are coated on a top surface of the rear substrate 110. A lower dielectric layer 115 for protecting the address electrodes 113 is formed between the address electrodes 113 and the phosphors 114.

A method of implementing image gray levels in this plasma display panel is shown in FIG. 2.

FIG. 2 is a view for illustrating a method of implementing image gray levels of a conventional plasma display panel.

As shown in FIG. 2, in the method of representing image gray levels in the conventional plasma display panel, one frame is divided into a plurality of sub-fields having a different number of emissions. Each of the sub-fields is subdivided into a reset period RPD for initializing the entire cells, an address period APD for selecting a cell to be discharged, and a sustain period SPD for implementing gray levels according to the number of discharges. For example, if it is desired to display images with 256 gray levels, a frame period (16.67 ms) corresponding to 1/60 seconds is divided into eight sub-fields SF1 to SF8, as shown in FIG. 2. Each of the eight sub-fields SF1 to SF8 is subdivided into a reset period, an address period and a sustain period.

The reset period and the address period of each of the sub-fields are the same every sub-field. The address discharge for selecting a cell to be discharged is generated by a voltage difference between transparent electrodes, i.e., the address electrodes and the scan electrodes. The sustain period increases in the ratio of 2ⁿ(where, n=0,1,2,3,4,5,6,7) in each sub-field. As such, since the sustain period is varied in each sub-field, gray levels of images are represented by controlling the sustain period of each sub-field, i.e., the number of sustain discharges. A drive waveform in this driving method of the plasma display panel will now be described with reference to FIG. 3.

FIG. 3 shows a drive waveform in a driving method of the conventional plasma display panel.

As shown in FIG. 3, the plasma display panel is driven with it being divided into a reset period for initializing all cells, an address period for selecting cells to be discharged, a sustain period for maintaining discharging of selected cells, and an erase period for erasing wall charges within discharged cells.

In a set-up period of the reset period, a rising ramp waveform (Ramp-up) is applied to the entire scan electrodes at the same time. The rising ramp waveform causes a weak dark discharge to occur within discharge cells of the entire screen. The set-up discharge causes positive wall charges to be accumulated on the address electrodes and the sustain electrode, and negative wall charges to be accumulated on the scan electrodes.

In a set-down period, after the rising ramp waveform is supplied, a falling ramp waveform (Ramp-down), which falls from a positive voltage lower than a peak voltage of the rising ramp waveform to a predetermined voltage level lower than a ground GND level voltage, generates a weak erase discharge within the cells, thus sufficiently erasing wall charges excessively formed on the scan electrodes. The set-down discharge also causes wall charges of the degree that an address discharge can be generated in a stable manner to uniformly remain within the cells.

In the address period, while a negative scan pulse is sequentially supplied to the scan electrodes, a positive data pulse is supplied to the address electrodes in synchronization with the scan pulse. As a voltage difference between the scan pulse and the data pulse and a wall voltage generated in the reset period are added, an address discharge is generated within the discharge cells to which the data pulse is supplied. Furthermore, wall charges of the degree that may generate a discharge when a sustain voltage Vs is applied are formed within cells selected by an address discharge. To the sustain electrode is applied a positive voltage Vz so that generation of erroneous discharge with the scan electrodes is prevented by reducing a voltage difference between the sustain electrode and the scan electrodes during a set-down period and an address period.

In the sustain period, a sustain pulse Sus is alternately supplied to the scan electrodes and the sustain electrodes. In cells selected by the address discharge, a sustain discharge, i.e., a display discharge is generated between the scan electrodes and the sustain electrodes whenever the sustain pulse is applied as the wall voltage within the cells and the sustain pulse are added.

After the sustain discharge is completed, in the erase period, a voltage of an erase ramp waveform (Ramp-ers) having a small pulse width and a low voltage level is applied to the sustain electrodes, thus erasing wall charges remaining within the cells of the entire screen.

In general, the conventional plasma display panel driven by the drive waveform has a problem that an error discharge is generated in the address period or sustain period when the peripheral temperature is too high or too low.

### SUMMARY OF THE INVENTION

Accordingly, an object of the present invention is to solve at least the problems and disadvantages of the background art.

An object of the presen invention is to provide a plasma display apparatus which can prevent the high/low temperature error discharge from occurring upon driving the plasma display panel.

A plasma display apparatus according to the present invention comprises a plasma display panel comprising a scan electrode and a sustain electrode, a scan driver for applying a negative voltage to the scan electrode before a reset period when the scan electrode is applied with a positive voltage and a sustain driver for applying a positive voltage to the sustain electrode while the scan electrode is applied with a negative voltage.

A plasma display apparatus according to the present invention comprises a plasma display panel comprising a scan electrode and a sustain electrode, a scan driver for applying a second waveform having a decreasing slope before a reset period when a first waveform having a increasing slope is applied to the scan electrode and a sustain driver for applying a rising waveform to the sustain electrode while the second waveform applied to the scan electrode.

A plasma display apparatus according to the present invention comprises a plasma display panel comprising a scan electrode and a sustain electrode, a scan driver for applying a second waveform having a decreasing slope before a reset period when a first waveform having a increasing slope is applied to the scan electrode and a sustain driver for applying a rising waveform having a voltage that is more than the absolute value of voltage of the second waveform to the sustain electrode while the second waveform applied to the scan electrode.

The present invention has an effect to make it possible to apply a predetermined waveform to the scan electrode Y or sustain electrode Z in the period before the reset period to thus reduce an error discharge created in the high/low temperature.

In addition, the present invention has an effect to make it possible to reduce the magnitude of voltage of rising ramp applied in the setup period of reset period.

### BRIEF DESCRIPTION OF THE DRAWINGS

The invention will be described in detail with reference to the following drawings in which like numerals refer to like elements.

FIG. 1 shows the construction of a common plasma display panel.

FIG. 2 is a view for illustrating a method of implementing image gray levels of a conventional plasma display panel.

FIG. 3 shows a driving waveform in a driving method of the conventional plasma display panel.

FIG. 4 is a view of schematically illustrating a plasma display apparatus according to the present invention.

FIG. 5 is a view for illustrating a driving method of a plasma display apparatus according to the present invention.

FIG. 6 is a comparison view of a rising ramp waveform applied to a sustain electrode during preliminary reset period with sustain pulse applied to the sustain electrode during sustain period upon driving a plasma display apparatus according to the present invention.

FIG. 7 is a view for illustrating the state of wall charges formed within a discharge cell in a reset period upon driving a plasma display apparatus according to the present invention.

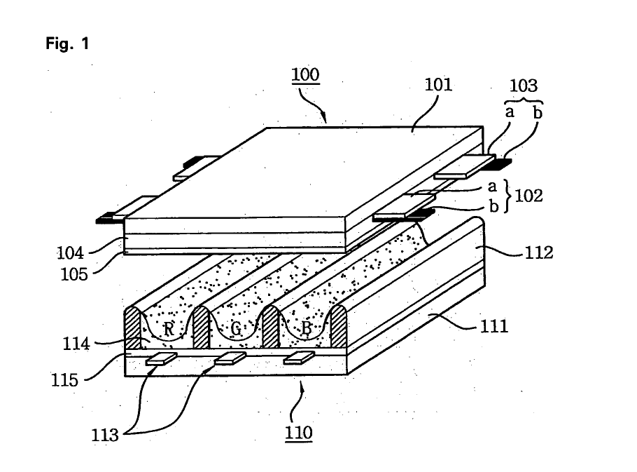

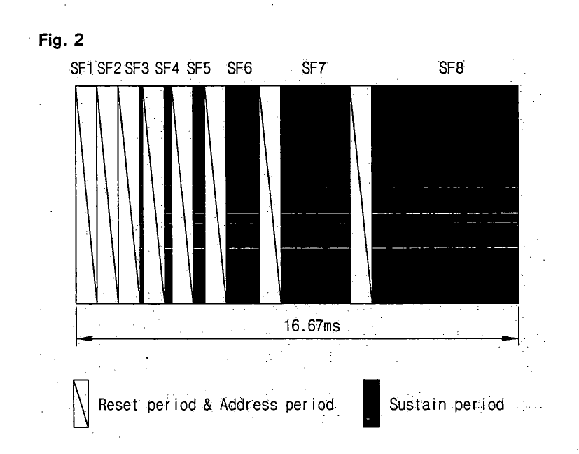

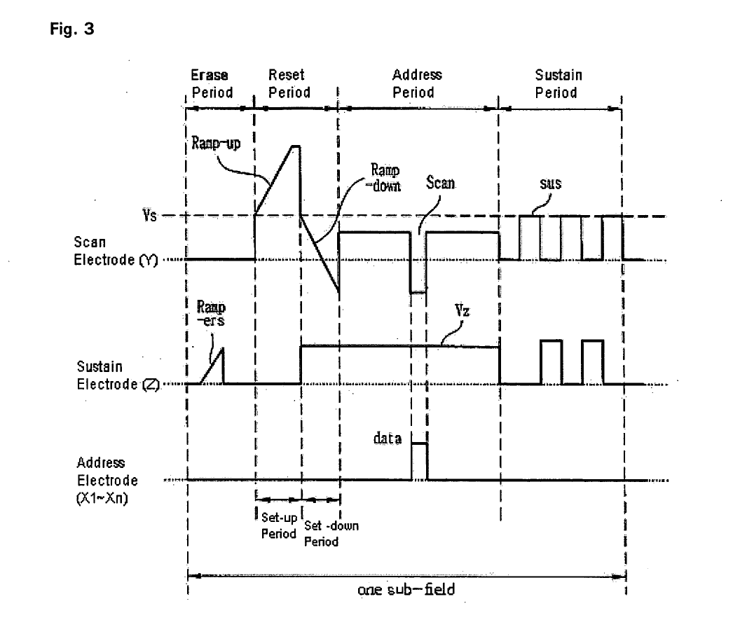

### DETAILED DESCRIPTION OF PREFERRED EMBODIMENTS

Preferred embodiments of the present invention will be described in a more detailed manner with reference to the drawings.

A plasma display apparatus according to the present invention comprises a plasma display panel comprising a scan electrode and a sustain electrode, a scan driver for applying a negative voltage to the scan electrode before a reset period when the scan electrode is applied with a positive voltage and a sustain driver for applying a positive voltage to the sustain electrode while the scan electrode is applied with a negative voltage.

A minimum value of the negative voltage applied to the scan electrode is equal to a minimum value of a scan pulse voltage applied in the address period.

The absolute value of the negative voltage is more than the absolute value of the positive voltage applied to the sustain electrode.

The magnitude of the positive voltage applied to the sustain electrode is more than 150V and less than 230V.

A voltage difference between the negative voltage applied to the scan electrode and the positive voltage applied to the sustain electrode is more than 1.5 times and less than 3 times the voltage of the sustain pulse applied in the sustain period.

A plasma display apparatus according to the present invention comprises a plasma display panel comprising a scan electrode and a sustain electrode, a scan driver for applying a second waveform having a decreasing slope before a reset period when a first waveform having a increasing slope is applied to the scan electrode and a sustain driver for applying a rising waveform to the sustain electrode while the second waveform applied to the scan electrode.

The rising waveform applied to the sustain electrode is a rectangular wave.

The voltage of the rising waveform is equal to the voltage of sustain pulse applied in the sustain period.

A rising time of the rectangular wave is more than 0.7 times and less than 1.5 times a rising time of the sustain pulse applied in the sustain period.

The length of the rising time of the rectangular wave is more than 200 ns and less than 800 ns.

A falling time of the rectangular wave is more than 0.7 times and less than 1.5 times a falling time of the sustain pulse applied in the sustain period.

The length of the falling time of the rectangular wave is more than 200 ns and less than 800 ns.

A plasma display apparatus according to the present invention comprises a plasma display panel comprising a scan electrode and a sustain electrode, a scan driver for applying a second waveform having a decreasing slope before a reset period when a first waveform having a increasing slope is applied to the scan electrode and a sustain driver for applying a rising waveform having a voltage that is more than the absolute value of voltage of the second waveform to the sustain electrode while the second waveform applied to the scan electrode.

The second waveform decreases from the ground level voltage to a predetermined voltage.

A minimum value of the second waveform is equal to a minimum value of the scan pulse voltage applied in the address period.

The voltage of the rising waveform applied to the sustain electrode is more than 150V and less than 230V.

The voltage of the rising waveform is equal to the voltage of the sustain pulse applied in the sustain period.

The rising waveform applied to the sustain electrode is a rectangular wave.

A rising time of the rectangular wave is more than 0.7 times and less than 1.5 times a rising time of the sustain pulse applied in the sustain period.

The length of the rising time of the rectangular wave is more than 200 ns and less than 800 ns.

Hereafter, a plasma display apparatus and a driving method thereof according to the present invention will be described in a more detailed manner with reference to the accompanying drawings.

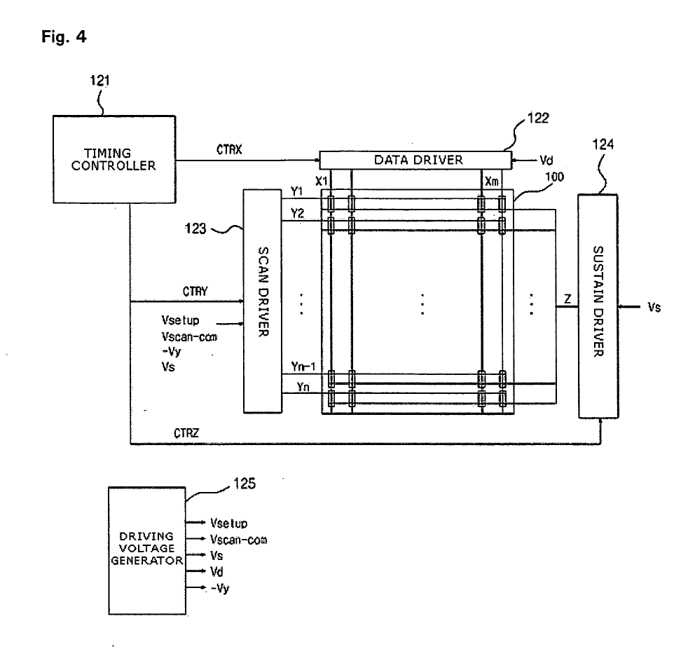

FIG. 4 is a view of schematically illustrating a plasma display apparatus according to the present invention.

As shown in FIG. 4, the plasma display apparatus according to the present invention comprises a plasma display panel 100, a data driver 122 for supplying data to address electrodes Xl to Xm formed on a lower substrate (not shown) of the plasma display panel 100, a scan driver 123 for driving scan electrodes Yl to Yn, a sustain driver 124 for driving sustain electrodes Z being common electrodes, a timing controller 121 for controlling the data driver 122, the scan driver 123, and the sustain driver 124 upon driving the plasma display panel, and a drive voltage generator 125 for supplying drive voltage requested for each driver 122, 123, and 124.

Firstly, the plasma display panel 100 has an upper substrate (not shown) and a lower substrate (not shown), both of which are combined with a predetermined interval. The upper substrate is formed with a plurality of electrodes, for example, pairs of scan electrodes Y1 to Yn and a pair of sustain electrodes Z, and the lower substrate is formed with address electrodes X1 to Xm to intersect the scan electrodes Y1 to Yn and sustain electrode Z.

The data driver 122 is supplied with data inverse gamma corrected and error diffused by an inverse gamma correction circuit and an error diffusion circuit, respectively, and then mapped to each sub-field by a sub-field mapping circuit. The data driver 122 samples and latches data corresponding to a timing control signal CTRX from the timing controller 121 and then supplies the data to the address electrodes X1 to Xm.

The sustain driver 123 supplies a predetermined waveform to the scan electrodes in the period before the reset period and the reset period of the sub-field under the control of the timing controller 121, subsequently supplies scan pulses Sp of the scan voltage—Vy to the scan electrodes Y1 to Yn in the address period, and supplies sustain pulses generated by an energy recovery circuit unit provided in the scan driver 123 to the scan electrode in the sustain period.

The sustain driver 124 also supplies a predetermined waveform to the sustain electrode in the period before the reset period and the reset period of the sub-field under the control of the timing controller 121. The sustain driver 124 supplies rising waveform to the sustain electrode while a second waveform is supplied to the scan electrode, and supplies positive voltage to the sustain electrode in order to prevent an error discharge from occurring in the address period by reducing a predetermined bias voltage, preferably, the voltage difference between the sustain electrode and the scan electrode in the address period. And, in the sustain period, a sustain drive circuit provided in the sustain driver 124 operates alternately with a sustain drive circuit provided in the scan driver 123 to supply sustain pulse sus to the sustain electrodes Z.

The timing controller 121 receives horizontal/vertical synchronization signals and a clock signal, generates timing control signals CTRX, CTRY, CTRZ to control the operation timing and synchronization of each driver 122, 123, and 124 in the reset period, address period, and sustain period, and supplies the timing control signals CTRX, CTRY, CTRZ to the corresponding drivers 122, 123, 124 to thereby control each driver 122, 123, 124.

The data control signal CTRX comprises a sampling clock for sampling data, a latch control signal, and a switch control signal for controlling on/off time of a sustain drive circuit and a drive switch element. The scan control signal CTRY comprises a switch control signal for controlling on/off time of a sustain drive circuit and a drive switch element within the scan driver 123, and the sustain control signal CTRZ comprises a switch control signal for controlling on/off time of a sustain drive circuit and a drive switch element within the sustain driver 124. p The drive voltage generator 125 generates a setup voltage Vsetup, a scan common voltage Vscan-com, a scan voltage—Vy, a sustain voltage Vs, a data voltage Vd, etc. The drive voltages can be varied depending on the composition of discharge gases or the construction of discharge cell.

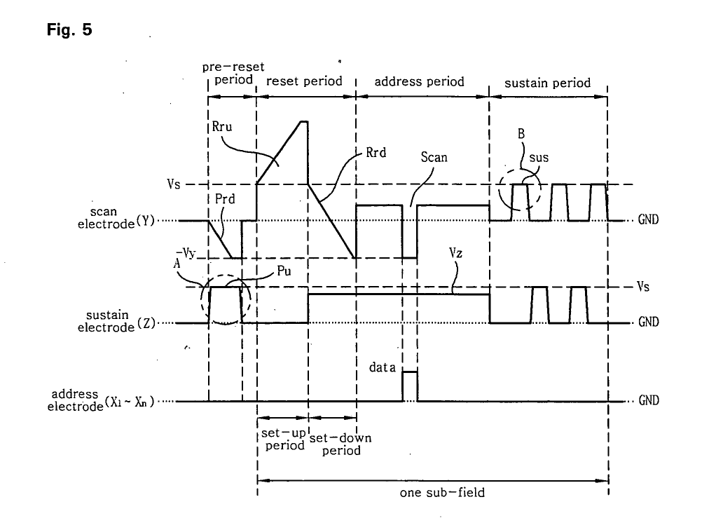

In the plasma display apparatus having the construction described above, each of the plurality of sub-fields are divided into a reset period, an address period, and a sustain period, and a predetermined signal is applied to the electrodes of the plasma display panel in each period to thus drive the plasma display panel. More specifically, the drive waveform as shown in FIG. 5 is applied to the electrodes formed on the plasma display panel, thus driving the plasma display panel.

FIG. 5 is a view for illustrating a driving method of a plasma display apparatus according to the present invention.

As shown in FIG. 5, a driving method of a plasma display panel according to the present invention comprises supplying a predetermined waveform to the scan electrode Y and sustain electrode in the period before the reset period. In other words, a falling waveform having a falling slope is supplied to the scan electrode Y in the period before the reset period, and a rising waveform having a positive voltage is supplied to the sustain electrode Z while the falling waveform is supplied to the scan electrode Y. At this time, the positive voltage having rising waveform supplied to the sustain electrode Z can be caused to be greater or smaller than the absolute value of voltage of falling waveform applied to the scan electrode Y according to the discharge property of plasma display panel.

As such, a comparison of the voltage of rising waveform with the voltage of falling waveform supplied to the scan electrode Y in the period before the reset period and the voltage of a sustain pulse supplied in the sustain period, which will be described later, shows the voltage difference between the voltage of falling waveform supplied to the scan electrode Y and the voltage of rising waveform supplied to the sustain electrode Z ranges between more than 1.5 times and less than 3 times as voltage of the sustain pulse supplied in the sustain period.

Hereafter, a rising waveform having an increasing slope in the set up period of the reset period is supplied to the scan electrode Y, and a falling waveform having a decreasing slope is supplied to the scan electrode in the set down period of the reset period. In addition, the sustain electrode Z sustains ground level GND in the set up period of the reset period, and a predetermined bias voltage in the set down period of the reset period.

As such, the period when the scan electrode Y and sustain electrode Z are supplied with a predetermined waveform in the period before the reset period, is termed as a preliminary reset period herein, the waveform having a decreasing slope at the scan electrode Y in the reset period is termed as a first waveform, and the waveform having an increasing slope in the preliminary reset period being the period before the reset period is termed as a second waveform.

As shown in FIG. 5, although the second waveform supplied to the scan electrode Y in the preliminary reset period is shown as a falling ramp waveform having a constantly decreasing slope, various types of waveforms can be generated according to the property in the discharge cell of plasma display panel. For example, if it is desired to drag space charges within discharge cell to the scan electrode more rapidly and strongerly, it is possible to supply the waveform similar to the rectangular wave to the scan electrode Y by sharpening the slope.

In addition, the second waveform supplied to the scan electrode Y in the preliminary reset period described above, can fall from positive voltage level to negative voltage level, and preferably, falls from ground level GND to negative voltage level. As such, the negative voltage level of the second waveform is equal to the lowest value of voltage of scan pulse supplied in the address period, which will be described later.

In addition, the rising waveform supplied to the sustain electrode Z in the preliminary period can have a gradually increasing or decreasing slope, or constantly changing slope. However, it is preferred that the rising waveform is a rectangular wave having a predetermined rising time and falling time. At this time, both of the rising time and the falling time of rising waveform, which have more than 200 ns and lower than 800 ns value, can be compared to the sustain pulse supplied in the sustain period, which will be described later.

In addition, it is preferred that the voltage of rising waveform is equal to that of sustain pulse in order to use the same voltage source as that of sustain pulse supplied in the sustain period. At this time, the voltage of rising waveform is more than 150V and less than 230V.

In the address period, the scan electrode Y is subsequently supplied with scan pulse of the scan voltage—Vy to the scan electrode Y. At this time, the sustain electrode Z is supplied with a predetermined positive bias voltage in order to prevent an error discharge from occurring in the address period by reducing a voltage difference from the scan electrode.

In the sustain period, the sustain pulse generated by an energy recovery circuit provided therein is supplied alternately to the scan electrode Y and sustain electrode Z. Accordingly, the discharge is sustained in the cells to be selected by discharge during the address period, and thus the cells display an image.

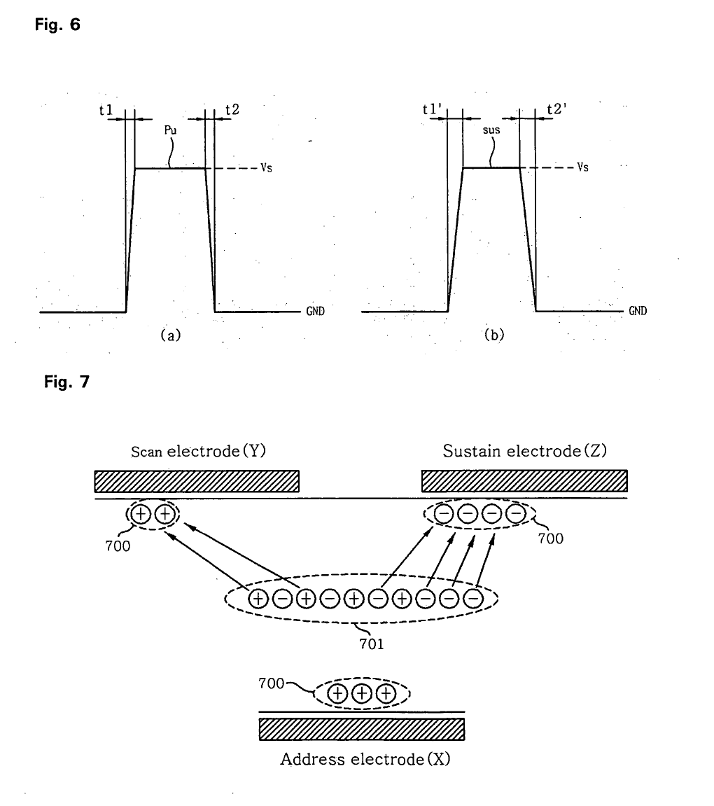

FIG. 6 is a comparison view of a rising ramp waveform applied to a sustain electrode during preliminary reset period with sustain pulse applied to the sustain electrode during sustain period upon driving a plasma display apparatus according to the present invention.

To compare the rising waveform shown with the sustain pulse, at first the rising time and falling time of rising waveform shown in (a) are defined. The rising time, which is the time taken of the rising waveform to reach from ground level GND to the maximum voltage Vs, is indicated by t1, and the falling time, which is the time taken of the rising waveform to reach from the maximum voltage Vs to ground level GND, is indicated by t2. In addition, the rising time and falling time of sustain pulse shown in (b) are defined. The rising time, which is the time taken of the sustain pulse to reach from ground level GND to the maximum voltage Vs, is indicated by t1′, and the falling time, which is the time taken of the sustain pulse to reach from the maximum voltage Vs to ground level GND, is indicated by t2′.

A comparison of the rising time and falling time of rising waveform with the rising time and falling time of sustain pulse shows that each of the rising time and falling time of rising waveform is more than 0.7 times and less than 1.5 times as each of the rising time and falling time of sustain pulse. The rising time and falling time of rising waveform can be adjusted different from the rising time and falling time of sustain pulse by determining discharge property, i.e. the state of wall voltage within discharge cell upon driving the plasma display panel. In the other hand, the preliminary reset period can be comprised in all the sub-fields, if it is considered that the plasma display apparatus according to the present invention is driven with a plurality of sub-fields divided to thus display an image, however, it can be comprised only in any sub-field of the plurality of sub-fields, as shown. Preferably, the preliminary reset period can be comprised only in sub-field having a lowest weight value of the plurality of sub-fields.

FIG. 7 is a view for illustrating the state of wall charges formed within a discharge cell in a reset period upon driving a plasma display apparatus according to the present invention.

Referring to FIG. 7, if the scan electrode Y is supplied with a negative voltage, and the sustain electrode Z is supplied with a positive voltage in the preliminary reset period as described above, the space charges 701 not participating in the discharge within a discharge cell are dragged to the scan electrode Y or sustain electrode Z to thus operate as wall charges 700. Accordingly, the absolute amount of space charges 701 is decreased and the amount of wall charges 700 located on the scan electrode or sustain electrode in the discharge cell is increased. As a result, it can be possible to prevent an high temperature error discharge from occuring, which can be created in case that temperature around the plasma display panel is high, the space charges 700 and wall charges 700, which do not participate in discharge within the discharge cell, are recombined with each other, and thus the absolute amount of wall charges 700 participating in discharge is decreased.

In addition, it is possible to prevent a low temperature error discharge from occuring since althoug the plasma discharge mechanism is slow, the absolute amount of wall charges is increased in case that the temperature around the plasma display panel is low. At this time, “high” means that the temperature ranges more than 40° C., and “low” means that the temperature ranges less than 0° C.

As such, an application of a predetermined waveform to the scan electrode Y or sustain electrode Z in the preliminary reset period can reduce the rate of error discharge generated in the high or low temperature.

In addition, the magnitude of voltage of rising ramp applied in the set up period of subsequent reset period can be reduced since the wall charges are accumulated within the discharge cell in the period before the reset period. This is why before the rising ramp, which serves as accumulating the wall charges in the discharge cell in the set up period of the reset period, is applied, a predetermined amount of wall charges are already accumulated in the preliminary reset period, therefore, although the magnitude of rising ramp is small, the sufficient amount of wall charges requested to set up can be accumulated in the discharge cell.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode and a sustain electrode;
a scan driver for applying a negative voltage to the scan electrode before a reset period when the scan electrode is applied with a positive voltage; and
a sustain driver for applying a positive voltage to the sustain electrode while the scan electrode is applied with a negative voltage.

2. The plasma display apparatus as claimed in claim 1, wherein
a minimum value of the negative voltage applied to the scan electrode is equal to a minimum value of a scan pulse voltage applied in the address period.

3. The plasma display apparatus as claimed in claim 1, wherein
the absolute value of the negative voltage is more than the absolute value of the positive voltage applied to the sustain electrode.

4. The plasma display apparatus as claimed in claim 1, wherein
the magnitude of the positive voltage applied to the sustain electrode is more than 150V and less than 230V.

5. The plasma display apparatus as claimed in claim 1, wherein
a voltage difference between the negative voltage applied to the scan electrode and the positive voltage applied to the sustain electrode is more than 1.5 times and less than 3 times the voltage of the sustain pulse applied in the sustain period.

6. A plasma display apparatus comprising:
a plasma display panel comprising a scan electrode and a sustain electrode;
a scan driver for applying a second waveform having a decreasing slope before a reset period when a first waveform having a increasing slope is applied to the scan electrode; and
a sustain driver for applying a rising waveform to the sustain electrode while the second waveform applied to the scan electrode.

7. The plasma display apparatus as claimed in claim 6, wherein
the rising waveform applied to the sustain electrode is a rectangular wave.

8. The plasma display apparatus as claimed in claim 6, wherein
the voltage of the rising waveform is equal to the voltage of sustain pulse applied in the sustain period.

9. The plasma display apparatus as claimed in claim 7, wherein
a rising time of the rectangular wave is more than 0.7 times and less than 1.5 times a rising time of the sustain pulse applied in the sustain period.

10. The plasma display apparatus as claimed in claim 9, wherein
the length of the rising time of the rectangular wave is more than 200 ns and less than 800 ns.

11. The plasma display apparatus as claimed in claim 7, wherein
a falling time of the rectangular wave is more than 0.7 times and less than 1.5 times a falling time of the sustain pulse applied in the sustain period.

12. The plasma display apparatus as claimed in claim 11, wherein
the length of the falling time of the rectangular wave is more than 200 ns and less than 800 ns.

13. A plasma display apparatus comprising:
a plasma display panel comprising a scan electrode and a sustain electrode;
a scan driver for applying a second waveform having a decreasing slope before a reset period when a first waveform having a increasing slope is applied to the scan electrode; and
a sustain driver for applying a rising waveform having a voltage that is more than the absolute value of voltage of the second waveform to the sustain electrode while the second waveform applied to the scan electrode.

14. The plasma display apparatus as claimed in claim 13, wherein
the second waveform decreases from the ground level voltage to a predetermined voltage.

15. The plasma display apparatus as claimed in claim 13, wherein
a minimum value of the second waveform is equal to a minimum value of the scan pulse voltage applied in the address period.

16. The plasma display apparatus as claimed in claim 13, wherein
the voltage of the rising waveform applied to the sustain electrode is more than 150V and less than 230V.

17. The plasma display apparatus as claimed in claim 13, wherein
the voltage of the rising waveform is equal to the voltage of the sustain pulse applied in the sustain period.

18. The plasma display apparatus as claimed in claim 13, wherein
the rising waveform applied to the sustain electrode is a rectangular wave.

19. The plasma display apparatus as claimed in claim 18, wherein
a rising time of the rectangular wave is more than 0.7 times and less than 1.5 times a rising time of the sustain pulse applied in the sustain period.

20. The plasma display apparatus as claimed in claim 19, wherein
the length of the rising time of the rectangular wave is more than 200 ns and less than 800 ns.
